(19) United States
(12) Patent Application Publication
(10) Pub. No.: US 2003/0182362 A1
(43) Pub. Date: Sep. 25, 2003

(54) System and method for distributed preference data services

(75) Inventors: Peter Strarup Jensen, Fremont, CA (US); Nikolay G. Grigoryev, St. Petersburg (RU)

Correspondence Address: MARTINE & PENILLA, LLP, 710 LAKEWAY DRIVE, SUITE 170, SUNNYVALE, CA, 94085, US

(73) Assignee: Sun Microsystems, Inc., Palo Alto, CA

(21) Appl. No.: 10/104,351

(22) Filed: Mar. 22, 2002

(51) Int. Cl. G06F 15/16

(52) U.S. Cl. 709/203

(57) ABSTRACT

An invention is provided for affording distributed preference data service. A plurality of storage providers is provided. Each storage provider provides access to a persistent data store that stores a set of data. In addition, each storage provider is registered with a storage provider registry. A storage provider that provides access to a particular set of data is selected using the storage provider registry, and the selected storage provider is used to access the particular set of data.

### CROSS REFERENCE TO RELATED APPLICATIONS

This application is related to (1) U.S. patent application Ser. No. ______ (Attorney Docket No. SUNMP084), filed Mar. 22, 2002, and entitled “Adaptive Connection Routing Over Multiple Communication Channels,” (2) U.S. patent application Ser. No. ______ (Attorney Docket No. SUNMP086), filed Mar. 22, 2002, and entitled “Arbitration of Communication Channel Bandwidth,” (3) U.S. patent application Ser. No. ______ (Attorney Docket No. SUNMP088), filed Mar. 22, 2002, and entitled “Asynchronous Protocol Framework,” (4) U.S. patent application Ser. No. ______ (Attorney Docket No. SUNMP089), filed Mar. 22, 2002, and entitled “Business-Model Agnostic Service Deployment Management Service,” (5) U.S. patent application Ser. No. ______ (Attorney Docket No. SUNMP090), filed Mar. 22, 2002, and entitled “Manager Level Device/Service Arbitrator,” (6) U.S. patent application Ser. No. ______ (Attorney Docket No. SUNMP092), filed Mar. 22, 2002, and entitled “Java Telematics System Preferences,” (7) U.S. patent application Ser. No. ______ (Attorney Docket No. SUNMP093), filed Mar. 22, 2002, and entitled “System and Method for Testing Telematics Software,” (8) U.S. patent application Ser. No. ______ (Attorney Docket No. SUNMP094), filed Mar. 22, 2002, and entitled “System and Method for Simulating an Input to a Telematics System,” (9) U.S. patent application Ser. No. ______ (Attorney Docket No. SUNMP095), filed Mar. 22, 2002, and entitled “Java Telematics Emulator,” and (10) U.S. patent application Ser. No. ______ (Attorney Docket No. SUNMP096), filed Mar. 22, 2002, and entitled “Abstract User Interface Manager with Prioritization,” which are incorporated herein be reference.

### BACKGROUND OF THE INVENTION

1. Field of the Invention

This invention relates generally to networked telematic computer devices, and more particularly to systems and methods for distributed preference data services.

2. Description of the Related Art

Telematics refers to systems used for communications, instrumentation, control, and information technology in the field of transportation. Over the years, manufacturers of on-road vehicles, such as automobiles, vans, trucks, buses, and so on, have utilized computer technology to enhance the operations of existing features and functions in the vehicles as well as to provide new features and functions. For example, programmed controllers, custom-designed processors, embedded systems, and/or computer modules have been developed that support or even control various kinds of mechanical equipment in vehicles. For example, programmed controllers or computer modules have been developed that control or support various engine functions, such as fuel injection, timing, and so on. Programmed controllers or computer modules have been developed to enhance or support operation of transmission systems, suspension systems, braking systems, and so on. The sophistication of these enhancements has advanced as the processing power available for these purposes has increased. It is expected that in the future more aspects of the mechanical equipment in vehicles will be controlled or supported by processors or controllers in order to enhance performance, reliability, and safety, to reduce emissions, and so on.

Aside from using computer technology to support various mechanical functions in vehicles, processors, controllers, or other programmed computer-based technologies are used in vehicles in other ways. Car phones, entertainment equipment (such as CD players), in-vehicle navigation systems, and emergency roadside assistance systems are examples. In addition, new kinds of equipment that provide entirely new features may become available in vehicles. For example, vehicles may include radar systems that detect obstacles on the road ahead and then automatically brake the vehicle to prevent accidents. Another example is an in-vehicle email system that automatically downloads and reads the driver's email. These new kinds of equipment are likely to include one or more processors and appropriate programming.

These new kinds of equipment hold the promise of making the operation of a vehicle safer, more reliable, less polluting, and more enjoyable. However, there are several considerations related to providing these kinds of features that constrain implementation. One consideration relates to the ability to provide user preference data to the vehicle devices. In particular, preference data can be immense, thus causing delays during search processes. Moreover, preference data can be of different types, that is, some preference data types may be written often to storage while other preference data types are not often written, but instead are read often. Furthermore, preference data should be accessible in a distributed manner, rather than locally stored on each vehicle device.

In view of the foregoing, there is a need for a mechanism for providing distributed preference data services. The mechanism should provide for search filtering and provide for optimized data storage and access.

### SUMMARY OF THE INVENTION

Broadly speaking, the present invention fills these needs by disclosing a service provider that provides distributed preference data services. In one embodiment, a method for providing distributed preference data service is disclosed. A plurality of storage providers is provided. Each storage provider provides access to a persistent data store that stores a set of data. In addition, each storage provider is registered with a storage provider registry. A storage provider that provides access to a particular set of data is selected using the storage provider registry, and the selected storage provider is used to access the particular set of data.

In an additional embodiment, a system for distributed preference data services is disclosed. The system includes a storage provider registry, and a plurality of storage providers. Each storage provider is in communication with a persistent data store that stores a set of data, and each service provider is further optimized for a particular purpose. In addition, each storage provider is registered with the storage provider registry, such that the storage provider registry is capable of selecting a particular storage provider that provides access to a particular set of data.

A service provider for distributed preference data services is disclosed in a further embodiment of the present invention. The service provider includes a front-end component that is in communication with a plurality of preference services. Each preference service provides access to a set of preferences for an application. The service provider also includes a preference cache component that is in communication with the front-end component. The preference cache component is capable of locally caching a set of preferences. Further, the service provider includes a storage provider registry that stores structure information associated with a plurality of storage providers. Each set of structured information stored in the storage provider registry indicates an optimized particular purpose of a particular storage provider. In operation, the preference cache component caches a set of preference data using a particular storage provider selected from the storage provider registry. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a diagram showing an exemplary wireless telematics system, in accordance with an embodiment of the present invention;

FIG. 2A is a functional diagram showing an exemplary telematic server, in accordance with an embodiment of the present invention;

FIG. 2B is a block diagram an exemplary telematic server architecture, in accordance with an embodiment of the present invention;

FIG. 3 is a block diagram showing an exemplary distributed service provider system for providing distributed data preference services, in accordance with an embodiment of the present invention;

FIG. 4 is a block diagram showing an internal view of the service provider, in accordance with an embodiment of the present invention; and

FIG. 5 is a flowchart showing a method for providing distributed data services, in accordance with an embodiment of the present invention.

### DETAILED DESCRIPTION OF THE PREFERRED EMBODIMENTS

An invention is disclosed for a service provider that provides distributed preference data services. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

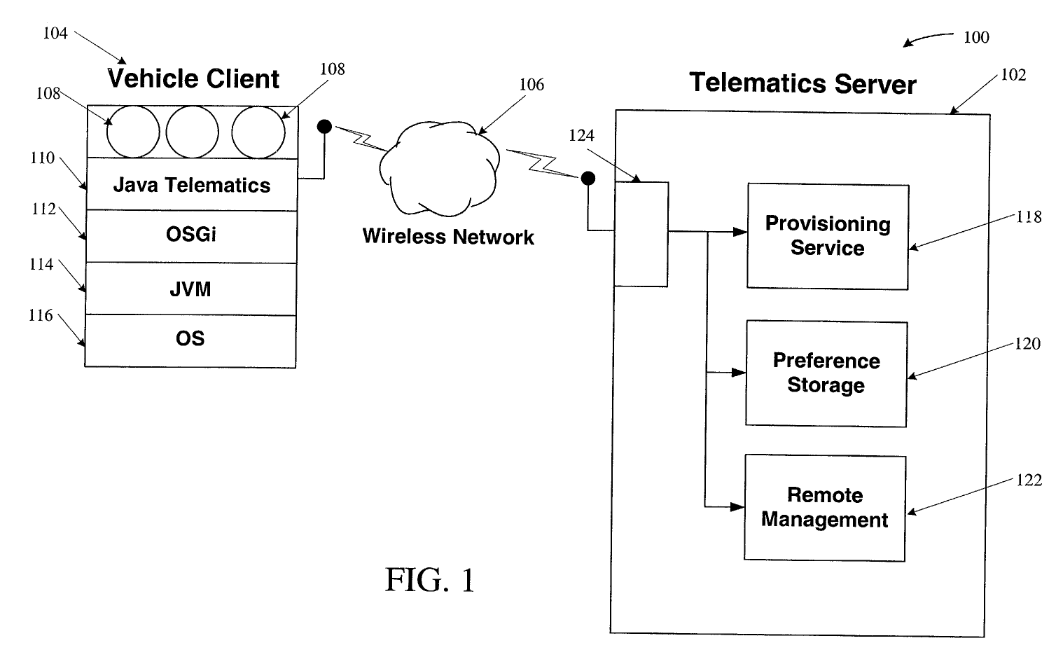

FIG. 1 is a diagram showing an exemplary wireless telematics system 100, in accordance with an embodiment of the present invention. As shown in FIG. 1, the wireless telematics system 100 includes a telematics server 102 in communication with a vehicle client 104 via a wireless network 106. The vehicle client 104 is generally implemented on a vehicle such as a car truck or van to provide enhanced functionality, such as navigation, entertainment, and communication. In one embodiment, the vehicle client 104 includes a plurality of carlets 108, which are individual software programs that provide specific functionality to the vehicle client 104. In addition, the vehicle client 104 generally includes a plurality of software layers, such as a Java telematics layer 110, an open services gateway initiative layer 112 (OSGi), a Java virtual machine layer 114, and an operating system 116.

The vehicle client 104 can be executed on a vehicle computing platform, which may include an interactive screen, global positioning satellite (GPS) system hardware, audio speakers, and microphone. In addition, the vehicle computing platform may include voice recognition software and speech generation capability. Further, the vehicle computing platform may be in communication with a vehicle bus, which allows communication with vehicle sensors to provide vehicle diagnostic information. As mentioned above, the vehicle client 104 can communicate wirelessly with the telematics server 102.

The telematics server 102 receives wireless communications using a communications application programming interface (API) framework 124. The communications API framework 124 provides a standardized framework for processing wireless communications independent of the actual physical networking hardware used for the wireless communications. In addition the communications API framework 124 allows communications with multiple networks, both wireless and non-wireless, such as the Internet.

Broadly speaking, the telematics server 102 includes provisioning service 118, preference storage 120, and remote management 122. The provisioning service 118 manages and provides the provisioning and downloading of carlets 108 to individual vehicle clients 104. In this manner the provisioning service 118 allows dynamic updating of the software functionality (i.e., carlets 108). For example, a user can subscribe to a particular service using a web page that is in communication with the telematics server 102. In response, the telematics server 102 can utilize the provisioning service 118 to deploy to the user's vehicle client 104, the carlets 108 associated with the particular service subscribed to by the user. When deploying carlets 108 to vehicle clients 104, embodiments of the present invention store user preferences using the preference storage 120.

Broadly speaking, the preference storage 120 is a storage of user preferences that can be made available to the computing platform executing the vehicle client 104. In addition, the vehicle client 104 can cache a portion of, or the entire contents of, the user's preference data stored in the preference storage 120. As above, a user may access the telematics server 102 via a web application to update their user preferences. Thereafter, the vehicle client 104 may request the updated user preferences from the preference storage 120. In this manner, a user can update their user preferences without having to utilize a limited vehicle computing platform interface.

The remote management 122 allows the telematics server 102 to manage the software and preferences on individual vehicle clients 104. For example, the remote management 122 can contact a vehicle client 104 and query information as to which carlets 108 are installed on the vehicle client 104. Further the remote management 122 can control the installing and uninstalling of applications and request vehicle status. In this manner, the telematics server 102 can remotely manage the vehicle clients 104.

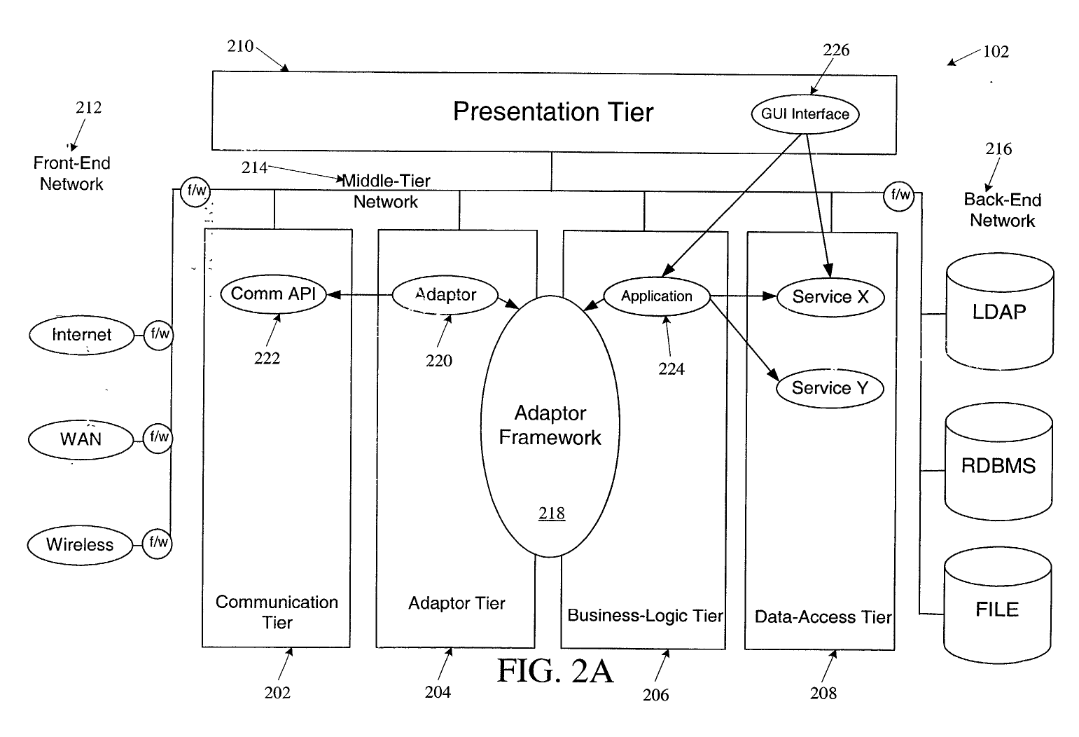

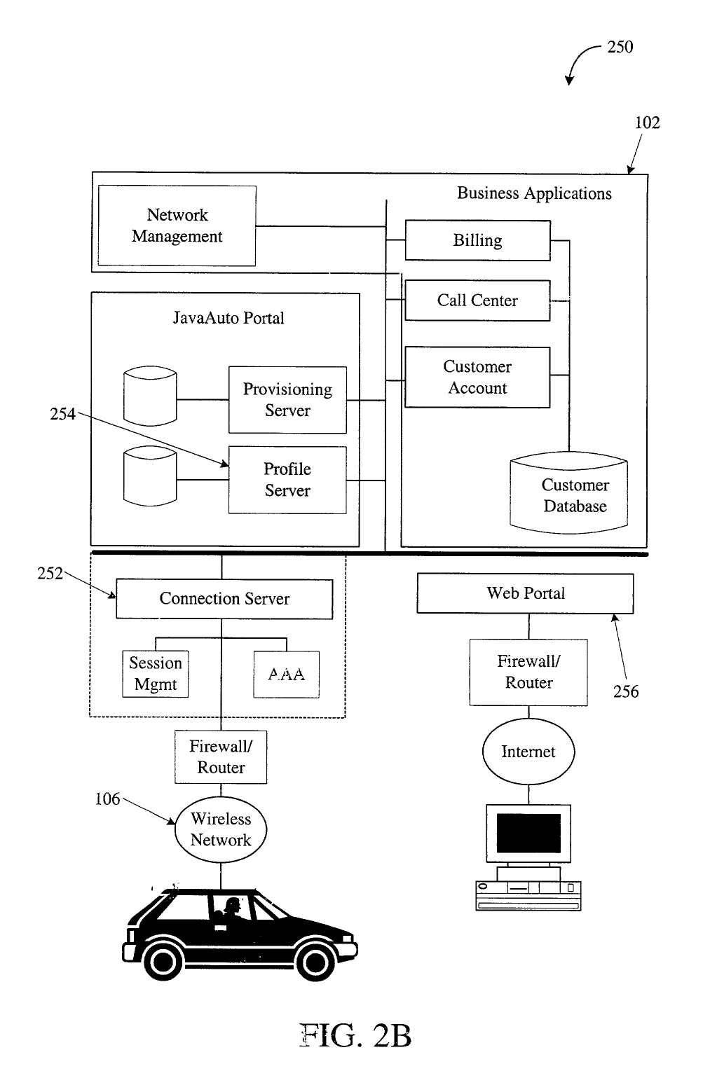

FIG. 2A is a functional diagram showing an exemplary telematic server 200, in accordance with an embodiment of the present invention. The telematic server 200 generally is organized into five logical tiers, namely, the communication tier 202, the adaptor tier 204, the business-logic tier 206, the data-access tier 208, and the presentation tier 210.

FIG. 2A depicts the five logical tiers of the telematic server 102 and illustrates how the logical tiers relate to a typical network architecture, in this case comprised of three logical network-tiers: front-end network 212 (or DMZ), middle-tier network 214 (or application network), back-end network 216 (or information-systems network). It should be noted that FIG. 2A shows a logical network architecture. In a development environment, there can be only one physical network, while a deployment environment can include multiple physical networks separated by firewalls. For example, although the communication tier 202 is shown connected to both the front-end 212 and the middle-tier network 214, a physical machine is not required to be connected to both networks. The connection illustrates that the implementation of components in the communication tier 202 may be distributed across machines connected to either network.

The components depicted in FIG. 2A show the general model of how end-to-end applications or services are implemented in the telematic server 102. The client-side of the typical service is implemented by a service-bundle, which can be deployed to and executed on a vehicle client device. A service-bundle is an archive containing executable code (e.g. carlets), resources (e.g. images and error messages in appropriate languages), configuration and descriptive information.

The vehicle client device communicates with the telematic server 102 through a deployment specific network, abstracted by communication APIs 222 in the communication tier 202. On the server-side, an adaptor 220 handles the application-level communication management (e.g. open, accept and close connections, send and receive data, etc.). Through the adaptor framework 218 the adaptor 220 is bound to an application component 224 implementing the server-side business-logic. The adaptor framework 218 allows adaptors 220 and applications 224 to be developed and deployed independently. Application components 224 are typically implemented using one or more generic services provided by the data-access tier 208.

In addition to any user interfaces provided by the client device, an end-to-end service may be accessible through other user interfaces 226, implemented in the presentation tier 210. This may include both applications for use by the service provider's employees or agents (e.g. client device administration, call centers, etc.), and customers (e.g. subscription management and other web services).

The communication tier 202 includes components implementing network protocols and interfaces. By using the APIs offered by communication tier 202, components in other tiers can communicate with remote vehicle client devices, as well as other types of clients, such as web-browsers. The communication tier 202 is connected to the front-end network 212 through which external networks (e.g. internet, wireless client network, etc.) are accessible. In addition, the communication tier 202 is connected to the middle-tier network 214, thus making the various communication APIs available to the other logical tiers.

In one embodiment, the communication tier 202 provides Intranet and Internet APIs, and telematic server communication APIs. The Intranet and Internet APIs can be provided by a general J2EE platform. Depending on the deployment, these APIs may or may not be available for communication with client devices. The telematic server communication APIs can be used to communicate with client devices supporting a compatible (interoperable) implementation of the corresponding client-side communication APIs, such as vehicle clients.

In order to abstract away from the specific communication mechanisms and application-level protocols employed by different types of client devices, the telematic server 102 defines a protocol API. The protocol API abstracts the generic application-level protocol that the telematic server 102 supports. In one embodiment, the protocol API includes a collection of request and reply handler interfaces. Handlers for incoming communications (requests and replies) are implemented by applications 224, while handlers for outgoing communications (requests and replies) are implemented by adaptors 220. For example, an application 224 may provide an interface that allows the application 224 to handle a client's request for a list of available services, while an adaptor 220 may provide an interface for sending such a list to a client.

Adaptors 220 provide client-specific application-level protocol management and communication. An adaptor 220 uses the communication APIs 222 offered by the communication tier 202 to communicate with individual vehicle client devices. In a simple case there is a one-to-one correspondence between the application-level protocol supported by the vehicle client and by the generic protocol reflected by the telematic server protocol API. That is, any communication received by an adaptor 220 will result in the invocation of a method on the interface of an appropriated application 224, and any invocation of a method on an adaptor API will result in a message being sent to a client device.

However, if the application-level protocol supported by the client doesn't match the telematic server protocol API, then the adaptor 220 is also responsible for mapping the client specific protocol to the telematic server protocol API. For example, a single request from a vehicle client device may require multiple requests to one or more applications 224.

The business-logic tier 206 includes components called applications 224. Applications 224 include the deployment specific business logic required to implement particular services. For example, a service discovery application may be responsible for calculating a reply when a client requests a list of available services. How to format the reply and how to send it is defined by a client specific protocol definition, and implemented by an adaptor 220. However, determining the content of the service list depends on the deployment's business rules. For example, the list could be pre-defined by the customer's service agreement, or the list might be calculated dynamically based on the vehicle client device's capabilities, or on other factors such as location.

In addition to the interface for handling incoming communications, an application 224 may provide a second interface, providing access to business functions. For example, a continuously running remote client management application may provide an interface for scheduling management activities, use an adaptor 220 to send directives to vehicle client devices at the scheduled time, and implement a reply handler interface allowing the adaptor 220 to deliver asynchronous replies.

The adaptor framework 218 supports, registration of adaptors 220 and applications 224, lookup of adaptors 220 and applications 224, binding between adaptors 220 and applications 224, and allowing adaptors 220 to pass strongly typed messages to appropriated applications 224 by invoking methods defined in the application interface, and vice versa.

The adaptor framework 218 allows an adaptor 220 to specify the appropriated application 224 (or vice versa), based on type, implementation and session. For example, a vehicle client specific service-discovery adaptor 220 may receive a request for a list of available services. After parsing and validating the request, the adaptor 220 tries to lookup a reference to a vehicle client (implementation) service-discovery (type) application to handle the request.

If any vehicle client service-discovery applications are registered with the adaptor framework 218, then the reference is bound to one of them (if there is more than one, the choice is implementation specific). If there are none, the adaptor framework 218 will attempt to bind to a default, client type neutral, service-discovery application. Assuming a suitable application is found, the adaptor 220 forwards the request to the application, passing along a reply address. If the client/server protocol uses asynchronous messaging, then the return address supplied by the adaptor may simply specify that the reply should go to any vehicle client service-discovery adaptor. But, if instead, the client/server protocol is based on synchronous communication, the adaptor creates a session and includes the session identifier in the return address, thus allowing the application to reply to the same adaptor. When the application is ready it uses the reply address in the request to lookup a reference to an adaptor and sends the reply.

The data-access tier 208 includes generic services for storing, managing and accessing deployment data. In general, a given service may be used by multiple applications 224, just as an application 224 may make use of multiple services. On one side the data-access tier 208 is connected to the middle-tier network 214, making services available to applications 224 in the business-logic tier 206, and to the presentation tier 210. On the other side, the data-access tier 208 connects to the back-end network 216 through which data storage systems (e.g. RDBMS, LDAP, file-servers, etc) are accessed, using existing J2EE APIs (e.g. JDBC, JNDI).

The presentation tier 210 includes various end-user interfaces available to the service provider's employees, agents or customers, through Internet or Intranet connectivity as appropriated. In addition to graphical user interfaces 226, the presentation tier 210 may include command-line utilities (scripts and programs) more appropriated for batch mode of operation (e.g. convert a existing customer database). Besides using various Internet and Intranet communication APIs, the components in the presentation tier 210 generally use the APIs of components in the data-access 208 and business-logic 206 tiers.

FIG. 2B is a block diagram an exemplary telematic server architecture 250, in accordance with an embodiment of the present invention. The telematic server architecture 250 illustrates the interaction of components including the connection server 252 and the profile server 254, often accessed via a web portal 256.

The connection server 252 establishes, accepts, maintains, and terminates connections over the wireless network. In addition, the connection server 252 interacts with a security server to maintain secure end-to-end sessions. Further, the connection server 252 is responsible for both incoming and outgoing connections. The API for the telematic server 102 includes functions for making connections to vehicles. This includes support for both synchronous and asynchronous communication. Communication can be subject to prioritization, allowing the implementation to arbitrate limited network resources. Further, the telematic API masks the developer from the details of the actual network and carrier infrastructure.

Generic security can also be provided by the telematic server architecture 250. For example, security features can include authentication, authorization, encryption, and session management. For example, the communication system can be required to mutually authenticate the server and client devices, and only accept communication from authorized sources.

In addition, the communication system of the telematic server architecture 250 ensures data integrity and privacy. In addition, the system may provide application-level security features to allow a common notion of “users” inside the server (e.g., a customer logging into a web-portal) and on client devices (e.g., the driver of a vehicle identified by their ignition key, or otherwise).

The telematics server 102 manages a database in which all deployed (or deployable) services are stored. This database may also store information about client devices. The service repository supports dynamic characterization and categorization of services for different purposes (e.g., the service available to a particular device, the category of games, the set of services a given customer has subscribed to, etc.).

The telematics server 102 provides service APIs for controlling deployment of services to vehicles. More specifically the telematics server 102 supports service discovery, service subscription, and service delivery. Using service discovery, vehicle clients can query the telematics server 102 for lists of services based on service categories and matching criteria, to determine the set of services available to a given device. Using service subscription, telematics server 102 can support management of individual service categories (e.g., the set of services a given customer has subscribed to). Using service delivery, telematics server 102 allows vehicle client devices to download services (subject to authorization). This can involve downloading service implementation components or other resources from 3rd party service providers to a local cache. In addition, the telematics server 102 performs service version management, and provides APIs to remotely manage deployed services (e.g., start, stop, uninstall, upgrade, change configuration, etc.).

The profile server 254 manages a database containing users' preferences data. Thus, the profile server 254 allows clients to read and write user and service-specific preferences (subject to authorization). In addition, the profile server 254 provides an API allowing server-side access to preferences as well. For example, a user can log into a web-portal 256 and modify their personal radio station preferences, using a convenient web interface, and later find the updated preferences installed in their vehicle.

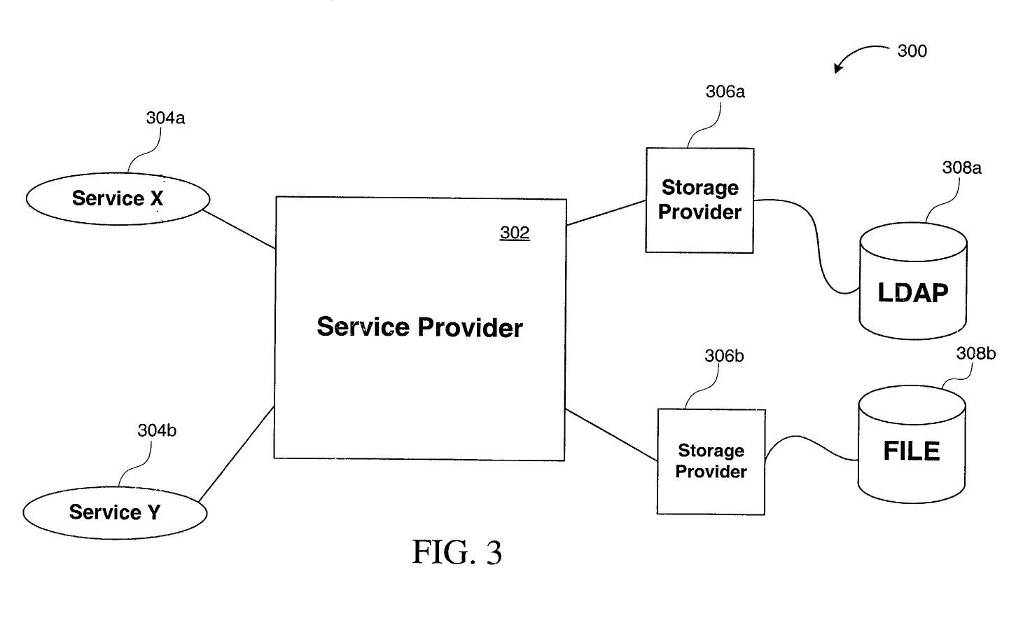

As mentioned above, embodiments of the present invention store user preference data using preference storage 120 functionality within the data-access tier 208. In particular, embodiments of the present invention utilize service providers to provide access and manage user preference data. FIG. 3 is a block diagram showing an exemplary distributed service provider system 300 for providing distributed data preference services, in accordance with an embodiment of the present invention. Generally, embodiments of the present invention store preference data using key/value attributes organized in a tree. A preference tree can include a root preference node having a set of key/value attributes and a set of child preference nodes. As discussed in greater detail subsequently, embodiments of the present invention allow vehicle clients to access preference data from any location within the network.

The distributed service provider system 300 includes a service provider 302 in communication with a plurality of preference services 304a-304b. In addition, the service provider 302 is in communication with a plurality of storage providers 306a-306b, which provide access to one or more persistent data stores 308a-308b. Each preference service 304a-304b is a service that uses and provides access to a set of preferences. For example, preference service 304a could provide user preference data to an application 224, which is performing remote business-logic for a vehicle carlet 108. To allow the preference data to be accessible in a distributed manner, the preference services 304a-304b utilize the service provider 302.

The service provider 302 manages access to sets of preferences on behalf of the preference services 304a-304b. To this end, the service provider 302 creates and destroys sets of preferences. In addition, the service provider 302 searches for particular sets of preferences based on search-filters, for example using LDAP search-filter syntax, matched against the structure and data content of the sets of preferences managed by the service provider 302.

To access the persistent data stores 308a-308b, the service provider 302 utilizes storage providers 306a-306b. In one embodiment, the service provider 302 can be configured to utilize different storage providers 306a-306b for different sets of preferences. Each storage provider 306a-306b manages the connection to a persistent data store 308a-308b, in which the actual preference data is stored. In one embodiment, the persistent data stores 308a-308b reside on a different network accessed via a fire-wall. Although FIG. 3 illustrates two preference services 304a-304b in communication with the service provider 302, it should be noted that any number of preference services can be included in the distributed service provider system 300. Similarly, it should be noted that any number of storage providers can be included in the system.

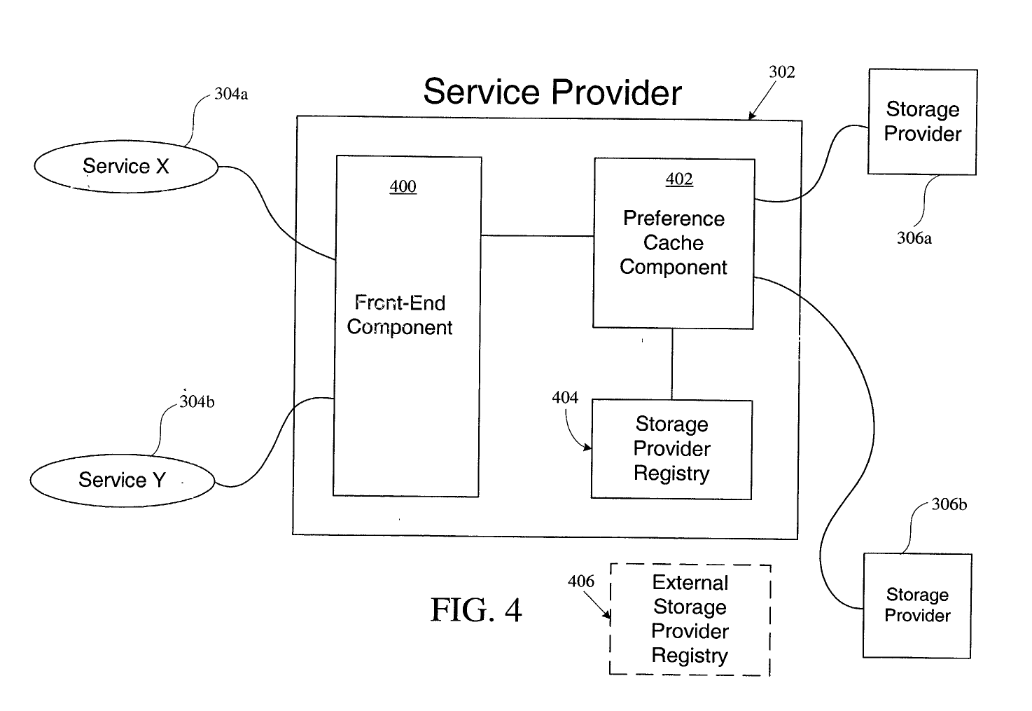

FIG. 4 is a block diagram showing an internal view of the service provider 302, in accordance with an embodiment of the present invention. The service provider 302 includes a front-end component 400 in communication with the preference services 304a -304b and one or more preference cache components 402. Each preference cache component 402 is in communication with a storage provider registry 404 and a plurality of storage providers 308a-308b.

The front-end component 400 provides a remote interface used by the preference services 304a-304b to obtain services. More particularly, the front-end component 400 creates proxies for sets of preferences that can be retuned to the user of a preference service in order to provide access to the content of a set of preferences. In one embodiment, a preference service 304a-304b can request preference data from the service provider 302 using the front-end component 400. In addition, the preference service 304a-304b informs the front-end component 400 how to identify the returned preference data. In response, the front-end component 400 returns an object having the requested preference data, which is identified as requested.

Individual sets of preferences are represented using instances of the preference cache component 402. The preference cache component 402 implements generic, storage provider independent, caching logic. Thus, each preference cache component 402 caches and provides access to a particular set of preferences.

To select a correct storage provider 306a-306b to use for a particular set of preferences, the preference cache component 402 utilizes the storage provider registry 404. The storage provider registry 404 also stores configuration information for the individual storage providers 306a-306b, such as the network address for the persistent data stores. The storage provider registry 404 can further map preferences set identifiers and/or preference set search-filters to storage providers 306a-306b. Storage providers 306a-306b can be optimized for writing, reading, security, or other special operations. In such cases, the storage provider registry 404 stores the optimization information to facilitate selection of an appropriate storage provider 306a-306b for a particular operation.

As mentioned above, the storage provider registry 404 provides access to the various storage providers 306a-306b in the system. In this manner, different storage providers 306a-306b can provide access to different sets of preferences. More particularly, to connect a preference cache component 402 to a specific set of preference data, the storage provider registry 404 can be used to determine which storage provider 306a-306b can provide access to the specific set of preference data. Optionally, an external storage provider registry 406 can be utilized to select appropriate storage providers 306a-3063b. The external storage provider registry 406 allows new storage providers to be deployed dynamically, at runtime, without needing to redeploy the entire system.

In addition to searching for preferences using a preference identifier, embodiments of the present invention can utilize search-filters to specify a particular search pattern to use during the search operation. As mentioned above, the storage providers 306a-306b are registered using structured information, in addition to the preference set identifiers. The structured information allows the storage provider registry 404 to be searched using a given search pattern. In this manner, a storage provider can be selected based on the structured information, then further selected based on the set of preference data the storage provider can access.

For example, a storage provider having access to billing preference data can be stored in the storage provider registry 404 with structured information indicating it as a billing storage provider. When a request for a particular set of billing preference data is received, the storage provider registry 404 can be searched for the billing storage provider. Once this is obtained, the selected storage provider can be utilized to obtain the specific set of preference data from the preference tree stored on the related persistent data store. The requested set of preference data can then be cached using a preference cache component 402, and provided to the requesting preference service 304a-304b using the front-end component 400.

Each storage provider 306a-306b implements operations to read and write preference data to the persistent data store. In addition, each storage provider 306a-306b can implement operations to match search-filters against the tree content. For example, an LDAP based storage provider can support LDAP search filters by delegating the task to the persistent data store (i.e., the ILDAP database). In addition, to the storage providers, the preference cache component 402 can implement operations to match search-filters against the tree content. This generally occurs when the storage provider does not support search filter matching.

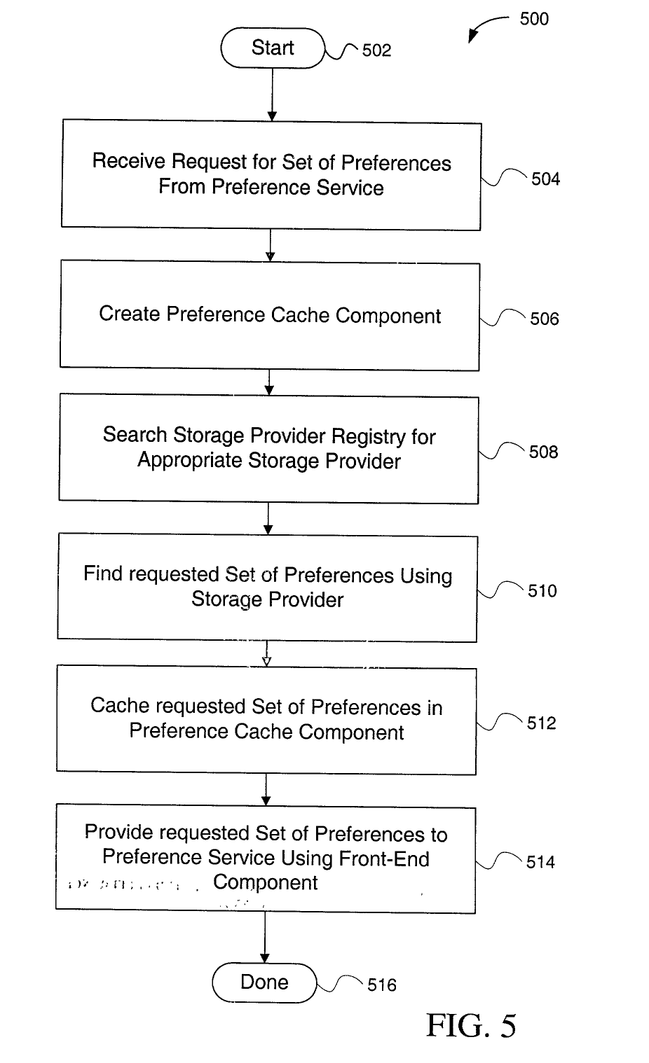

FIG. 5 is a flowchart showing a method 500 for providing distributed data services, in accordance with an embodiment of the present invention. In an initial operation 502, preprocess operations are performed. Preprocess operations can include configuring preference data trees, storing structured storage provider information within the storage provider registry, and other preprocess operations that will be apparent to those skilled in the art after a careful reading of the present disclosure.

In operation 504, a request for a set of preferences is received from a preference service. As mentioned above, preference services are services that use and provide access to a set of preferences. For example, preference service can provide user preference data to an application, which is performing remote business-logic for a vehicle carlet. To allow the preference data to accessible in a distributed manner, the preference services utilize the service provider. Hence, in operation 504, the service provider receives the request a set of preferences using the front-end component.

The front-end component provides a remote interface used by the preference services to obtain services. More particularly, the front-end component creates proxies for sets of preferences that can be retuned to the user of a preference service in order to provide access to the content of a set of preferences. In addition, the preference service informs the front-end component how to identify the returned preference data. In response, the front-end component returns an object having the requested preference data, which is identified as requested, as described in greater detail subsequently.

A preference cache component is created, in operation 506. The preference cache component implements generic, storage provider independent, caching logic. Thus, each preference cache component caches and provides access to a particular set of preferences. In operation 508, the storage provider registry is searched for an appropriate storage provider. The storage provider registry stores configuration information for the individual storage providers, such as the network address for the persistent data stores. The storage provider registry can further map preferences set identifiers and/or preference set search-filters to storage providers. The storage provider registry provides access to the various storage providers in the system, allowing different storage providers to provide access to different sets of preferences.

In operation 510, the requested set of preferences is obtained using the selected storage provider. Each storage provider implements operations to read and write preference data to the persistent data store. In addition, each storage provider can implement operations to match search-filters against the tree content. For example, an LDAP based storage provider can support LDAP search filters by delegating the task to the persistent data store (i.e., the LDAP database). In addition, to the storage providers, the preference cache component 402 can implement operations to match search-filters against the tree content. This generally occurs when the storage provider does not support search filter matching. Further, storage providers can be optimized for writing, reading, security, or other special operations. In such cases, the storage provider registry stores the optimization information to facilitate selection of an appropriate storage provider for a particular operation.

The requested set of preferences is cached in the preference cache component, in operation 512. To connect a preference cache component to a specific set of preference data, the storage provider registry can be used to determine which storage provider can provide access to the specific set of preference data. Optionally, an external storage provider registry can be utilized to select appropriate storage providers. The external storage provider registry allows new storage providers to be deployed dynamically, at runtime, without needing to redeploy the entire system.

In operation 514, the requested set of preferences is provided to the preference service using the front-end component. As mentioned previously, the front-end component is in communication with the preference services and one or more preference cache components, and provides a remote interface used by the preference services to obtain services. More particularly, the front-end component creates proxies for sets of preferences that can be retuned to the user of a preference service in order to provide access to the content of a set of preferences. In one embodiment, a preference service can request preference data from the service provider using the front-end component. In addition, the preference service informs the front-end component how to identify the returned preference data. In response, the front-end component returns an object having the requested preference data, which is identified as requested, in operation 514.

Post process operations are performed in operation 516. Post process operations can include utilization of the requested preference data, dynamic storage provider allocation using an external storage provider registry, and other post process operations that will be apparent to those skilled in the art after a careful reading of the present disclosure.

In one embodiment, the telematics system of the embodiments of the present invention can be implemented using the Java programming language. In general, developers design Java applications as hardware independent software modules, which are executed Java virtual machines. The Java virtual machine layer is developed to operate in conjunction with the native operating system of the particular hardware on which the vehicle clients and telematic server are to run. In this manner, Java applications can be ported from one hardware device to another without requiring updating of the application code.

Unlike most programming languages, in which a program is compiled into machine-dependent, executable program code, Java classes are compiled into machine independent byte-code class files which are executed by a machine-dependent virtual machine. The virtual machine provides a level of abstraction between the machine independence of the byte-code classes and the machine-dependent instruction set of the underlying computer hardware. A class loader is responsible for loading the byte-code class files as needed, and an interpreter or just-in-time compiler provides for the transformation of byte-codes into machine code.

More specifically, Java is a programming language designed to generate applications that can run on all hardware platforms, small, medium and large, without modification. Developed by Sun, Java has been promoted and geared heavily for the Web, both for public Web sites and intranets. Generally, Java programs can be called from within HTML documents or launched standalone. When a Java program runs from a Web page, it is called a “Java applet,” and when run on a Web server, the application is called a “servlet.”

Java is an interpreted language. The source code of a Java program is compiled into an intermediate language called “bytecode”. The bytecode is then converted (interpreted) into machine code at runtime. Upon finding a Java applet, the Web browser invokes a Java interpreter (Java Virtual Machine), which translates the bytecode into machine code and runs it. Thus, Java programs are not dependent on any specific hardware and will run in any computer with the Java Virtual Machine software. On the server side, Java programs can also be compiled into machine language for faster performance. However a compiled Java program loses hardware independence as a result.

Although the present invention is described based on the Java programming language, other programming languages may be used to implement the embodiments of the present invention, such as other object oriented programming languages. Object-oriented programming is a method of creating computer programs by combining certain fundamental building blocks, and creating relationships among and between the building blocks. The building blocks in object-oriented programming systems are called “objects.” An object is a programming unit that groups together a data structure (instance variables) and the operations (methods) that can use or affect that data. Thus, an object consists of data and one or more operations or procedures that can be performed on that data. The joining of data and operations into a unitary building block is called “encapsulation.” An object can be instructed to perform one of its methods when it receives a “message.” A message is a command or instruction to the object to execute a certain method. It consists of a method selection (name) and a plurality of arguments that are sent to an object. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. A class defines a type of object that typically includes both instance variables and methods for the class. An object class is used to create a particular instance of an object. An instance of an object class includes the variables and methods defined for the class. Multiple instances of the same class can be created from an object class. Each instance that is created from the object class is said to be of the same type or class.

A hierarchy of classes can be defined such that an object class definition has one or more subclasses. A subclass inherits its parent's (and grandparent's etc.) definition. Each subclass in the hierarchy may add to or modify the behavior specified by its parent class.

To illustrate, an employee object class can include “name” and “salary” instance variables and a “set_salary” method. Instances of the employee object class can be created, or instantiated for each employee in an organization. Each object instance is said to be of type “employee.” Each employee object instance includes the “name” and “salary” instance variables and the “set_salary” method. The values associated with the “name” and “salary” variables in each employee object instance contain the name and salary of an employee in the organization. A message can be sent to an employee's employee object instance to invoke the “set_salary” method to modify the employee's salary (i.e., the value associated with the “salary” variable in the employee's employee object).

An object is a generic term that is used in the object-oriented programming environment to refer to a module that contains related code and variables. A software application can be written using an object-oriented programming language whereby the program's functionality is implemented using objects. Examples of object-oriented programming languages include C++ as well as Java. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for providing distributed preference data service, comprising the operations of:
providing a plurality of storage providers, each storage provider providing access to a persistent data store storing a set of data;
registering each storage provider with a storage provider registry;
selecting a storage provider that provides access to a particular set of data using the storage provider registry; and
utilizing the selected storage provider to access the particular set of data.

2. A method as recited in claim 1, wherein the storage provider registry further stores structured information associated with each storage provider, the structured information allowing the storage provider registry to be searched using a particular search pattern.

3. A method as recited in claim 2, wherein each storage provider is optimized for a particular purpose.

4. A method as recited in claim 3, wherein the structured information indicates the optimized particular purpose of a particular storage provider.

5. A method as recited in claim 4, further comprising the operation of selecting a storage provider that provides access to a particular set of data using a search pattern based on a particular set of structured information.

6. A method as recited in claim 1, further comprising the operation of caching the particular set of data.

7. A method as recited in claim 6, wherein the particular set of data is a set of preferences.

8. A method as recited in claim 7, wherein the set of preferences is stored as a preference tree.

9. A system for distributed preference data services, comprising:
a storage provider registry; and
a plurality of storage providers, each storage provider in communication with a persistent data store storing a set of data, each service provider further optimized for a particular purpose,
wherein each storage provider is registered with the storage provider registry, and wherein the storage provider registry is capable of selecting a particular storage provider that provides access to a particular set of data.

10. A system as recited in claim 9, wherein the storage provider registry further stores structured information associated with each storage provider, the structured information allowing the storage provider registry to be searched using a particular search pattern.

11. A system as recited in claim 10, wherein the structured information indicates the optimized particular purpose of a particular storage provider.

12. A system as recited in claim 11, wherein the storage provider that provides access to a particular set of data is further selected using a search pattern based on a particular set of structured information.

13. A system as recited in claim 12, further comprising a preference cache component that caches the particular set of data.

14. A system as recited in claim 13, wherein the particular set of data is a set of preferences.

15. A system as recited in claim 14, wherein the set of preferences is stored as a preference tree.

16. A service provider for distributed preference data services, comprising:
a front-end component in communication with a plurality of preference services, each preference service providing access to a set of preferences for an application;
a preference cache component in communication with the front-end component, the preference cache component capable of locally caching a set of preferences; and
a storage provider registry that stores structure information associated with a plurality of storage providers, each structured information indicating an optimized particular purpose of a particular storage provider, wherein the preference cache component caches a set of preference data using a particular storage provider selected from the storage provider registry.

17. A service provider as recited in claim 16, wherein the storage provider registry is capable of being searched using a particular search pattern for a particular set of structured information.

18. A service provider as recited in claim 17, wherein the preference cache component can be shared by different preference services.

19. A service provider as recited in claim 16, wherein the storage provider registry is external to the service provider.

20. A service provider as recited in claim 19, wherein the external storage provider registry is configured to allow storage providers to be dynamically added during runtime.
